(19) United States
(12) Patent Application Publication
(10) Pub. No.: US 2016/0162151 A1
(43) Pub. Date: Jun. 9, 2016

(54) INPUT METHOD AND DEVICE THEREOF, AND AUXILIARY INPUT METHOD AND SYSTEM THEREOF

(71) Applicant: SHENZHEN SHI JI GUANG SU INFORMATION TECHNOLOGY CO., LTD., Shenzhen, Guangdong (CN)

(72) Inventor: Long XU, Shenzen City (CN)

(21) Appl. No.: 14/364,070

(22) PCT Filed: Dec. 31, 2013
(86) PCT No.: PCT/CN2013/090992

§ 371 Date: Jun. 9, 2014

(30) Foreign Application Priority Data
Mar. 4, 2013 (CN) 201310068955.6

(51) Int. Cl. G06F 3/0481; G06F 3/0484

(52) U.S. Cl. CPC G06F 3/04812; G06F 3/0484

(57) ABSTRACT

An input method includes: obtaining data information sent by an auxiliary terminal; obtaining a focus object and/or a cursor position displayed on a screen of the execution terminal; and adding the data information to an input area corresponding to the focus object and/or the cursor position on the screen. Furthermore, an input device, auxiliary input method, and auxiliary input system are further provided. With the input device, auxiliary input method, and auxiliary input system, the input speed can be improved.

### CROSS REFERENCE TO RELATED APPLICATIONS

The present application is a National Stage Application of International Application No. PCT/CN2013/090992, filed on Dec. 31, 2013, entitled “INPUT METHOD AND DEVICE THEREOF, AND AUXILIARY INPUT METHOD AND SYSTEM THEREOF” by Long XU, which claims the priority from the Chinese patent application No. CN 201310068955.6, filed on Mar. 4, 2013. The above-referenced applications are hereby incorporated herein in their entireties by reference.

### FIELD OF THE INVENTION

The present disclosure relates generally to the field of mobile Internet technology, and more particularly to an input method and device thereof, and an auxiliary input method and system thereof.

### BACKGROUND OF THE INVENTION

With the development of mobile Internet technology, smart terminals, such as smart phones and tablet computers, etc., have been widely used. A smart terminal has an operating system running on it, and an input application may be loaded by the system. A user can input text message by the input application. For example, text content including short messages, microblogging, blog, forum posts etc., can be edited by the user using a mobile phone input method.

In order to ensure the portability, smart terminals usually have poor hardware condition. For example, smart phones typically have smaller screen and keyboard, as well as relatively weaker computing capability. As a result, it is not convenient for the user to input text codes or to select words, and the input speed is low.

### SUMMARY OF THE INVENTION

To address the aforementioned deficiencies and inadequacies, there is a need to provide an input method which can increase the input speed.

An input method includes the steps of:

obtaining data information sent by an auxiliary terminal;

obtaining a focus object and/or a cursor position displayed on a screen of an execution terminal;

adding the data information to an input area of the screen of the execution terminal corresponding to the focus object and/or the cursor position on the screen.

Furthermore, there is a need to provide an input device which can increase the input speed.

An input device, includes:

a data receiving module, configured to obtain data information sent by an auxiliary terminal;

a positioning module, configured to obtain a focus object and/or a cursor position displayed on a screen of an execution terminal;

an adding module, configured to add the data information to an input area of the screen of the execution terminal corresponding to the focus object and/or the cursor position on the screen.

Furthermore, there is a need to provide an auxiliary input method which can increase the input speed.

An auxiliary input method, includes:

obtaining, by an auxiliary terminal, inputted data information, and sending the inputted data information to an execution terminal;

receiving, by the execution terminal, the data information sent by the auxiliary terminal, obtaining a focus object and/or a cursor position displayed on a screen of the execution terminal, and adding data information to an input area corresponding to the focus object and/or the cursor position on the screen.

Furthermore, there is a need to provide an auxiliary inputting system which can increase the input speed.

An auxiliary inputting system includes an execution terminal and an auxiliary terminal, wherein:

the auxiliary terminal is configured to obtain data information inputted by the auxiliary terminal and send the inputted data information to the execution terminal;

the execution terminal is configured to receive the data information sent by the auxiliary terminal, to obtain a focus object and/or a cursor position displayed on a screen of the execution terminal, and to add the data information to an input area corresponding to the focus object and/or the cursor position on the screen.

By the above input method and device thereof, and the auxiliary input method and system thereof, the operation of inputting data information can be separated from the execution terminal to an auxiliary terminal. The auxiliary terminal may have better inputting conditions, for example, with larger keyboard and more types of input devices. Thus, the user is allowed to use more convenient input tools of the auxiliary terminal, and thereby increasing the input speed.

### BRIEF DESCRIPTION OF THE DRAWINGS

FIG. 1 is a diagram showing an input method in an embodiment of the present disclosure.

FIG. 2 is a structural schematic diagram showing an input device in an embodiment of the present disclosure.

FIG. 3 is a structural schematic diagram showing an input device in an embodiment of the present disclosure.

FIG. 4 is a structural schematic diagram showing an input device in another embodiment of the present disclosure.

FIG. 5 is a diagram showing an auxiliary input method in an embodiment of the present disclosure.

FIG. 6 is a structural schematic diagram showing an inputting system in an embodiment of the present disclosure.

FIG. 7 is a structural schematic diagram showing an inputting system in another embodiment of the present disclosure.

### DETAILED DESCRIPTION OF THE PREFERRED EMBODIMENTS

In the following description of embodiments, reference is made to the accompanying drawings which form a part hereof, and in which it is shown by way of illustration specific embodiments of the disclosure that can be practiced. It is to be understood that other embodiments may be used and structural changes may be made without departing from the scope of the disclosed embodiments.

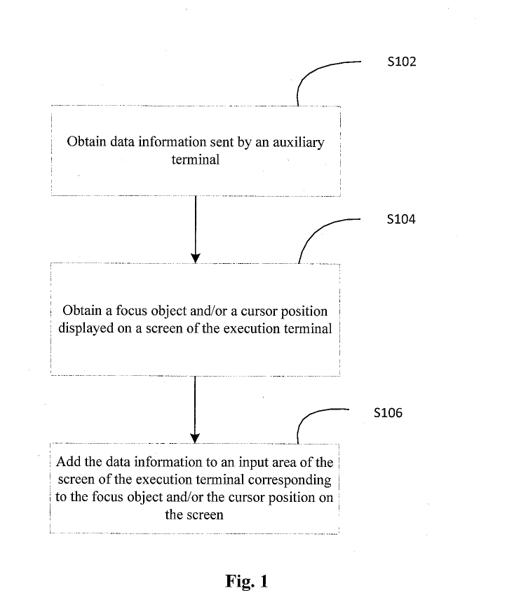

In an embodiment, as shown in FIG. 1, an input method includes the following steps.

Step S102: obtaining data information sent by an auxiliary terminal.

The auxiliary terminal is a terminal which assists a user to input on an execution terminal. When it is inconvenient to input on the execution terminal, the user can input data information by an auxiliary terminal which has better inputting environment. For example, a PC may be used as an auxiliary terminal to input data information via its physical keyboard.

In an embodiment, the method may further include, before the step of obtaining, the step of obtaining the inputted login information and logging in a server.

In the embodiment, the step of obtaining data information sent by an auxiliary terminal may include receiving data information in accordance with the login information forwarded by the server, and uploading, by the auxiliary terminal corresponding to the login information, the data information to the server.

In the embodiment, the user needs to log into the server in advance by inputting an account password on the execution terminal or using a cookie. Meanwhile, the user also needs to log into the server in advance by inputting an account password on the auxiliary terminal or using a cookie.

In the embodiment, the method further include, before the step of receiving data information corresponding to the login information forwarded by the server, the step of initiating an auxiliary input request to the server. The server may obtain a network address of the corresponding auxiliary terminal according to the login information (user ID and login IP, etc.), and forward the auxiliary input request to the auxiliary terminal. An input window can be displayed on the screen of the auxiliary terminal. Data information inputted into the input window can be obtained and uploaded to the server, and then forwarded by the server to the execution terminal.

In another embodiment, upon logging in both by the execution terminal and the auxiliary terminal, data information may be inputted directly by the auxiliary terminal and sent to the server, and then forwarded by the server to the execution terminal. In other words, it is not required to initiate the auxiliary input request by the execution terminal; instead, data information may be inputted directly upon logging in by the auxiliary terminal, and forwarded by the server to the execution terminal. The execution terminal receives the data information.

Step S104: obtaining a focus object and/or a cursor position displayed on a screen of an execution terminal.

Step S106: adding the data information to an input area of the screen of the execution terminal corresponding to the focus object and/or the cursor position on the screen.

A focus object is a view object in an active state. View objects may include text input box, rich text input box, etc. A cursor position is the position where to input, which may be obtained by calling the API function of the operating system. According to the cursor position, an input area and input position in the input area are positioned. The received data information is inserted into the input position. It is also possible to obtain a focus object by calling the API function of the operating system, and adding the received data information into the input area corresponding to the focus object.

In an embodiment, the data information may include at least one selected from the group consisting of: video data, image data, text data, audio data and application data.

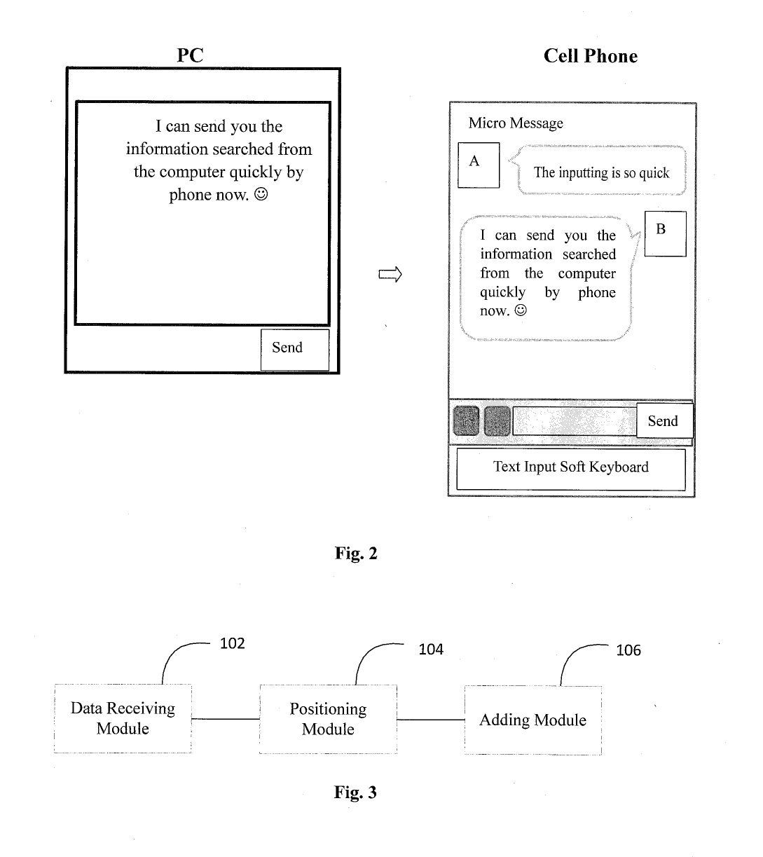

For example, the user may use a personal PC as an auxiliary terminal to obtain an image by screen capture, and paste the image into a pop-up input window of the auxiliary terminal. As shown in FIG. 2, the user may also input text data by using a keyboard to input Pinyin, Wubi or other text codes, and selecting the words, or by stylus and tablet, or inputting audio data via a microphone, inputting video data via a camera, inputting application data by copying and pasting.

In the embodiment, the data information is of corresponding MIME-type, for example, Multipurpose Internet Mail Extensions. Data information obtained is added into the input area corresponding to the focus object and/or cursor position and display according to its MIME-type.

For example, when the data information obtained is video data, its MIME-type is video (video/A, A is the video format, including mpeg, quicktime, etc.), which may be previewed by calling appropriate interface function for video play. When the data information obtained is audio data, its MIME-type is audio (video/B, B is the audio format, including mid, x-aiff, etc.), which may be previewed by calling appropriate interface function for audio play. When the data information obtained is application data, its MIME-type is application, which may be operated by calling appropriate application interface. For example, if the data information obtained is a pdf file, then its MIME-type is application/pdf, which can be previewed by calling appropriate interface function of pdf application.

In another embodiment, the step of obtaining data information sent by the auxiliary terminal further includes: obtaining terminal pairing information; obtaining connection with the auxiliary terminal according to the terminal pairing information; receiving data information according to the connection with the auxiliary terminal.

After pairing with the auxiliary terminal, a long connection may be maintained, or only the network location or device identification of the auxiliary terminal are obtained and recorded in the terminal pairing information. Then, before receiving data sent by the auxiliary terminal, a connection with the auxiliary terminal may be established according to the network location or device identification recorded in the terminal pairing information.

In the embodiment, the method may further include, before the step of obtaining data information sent by the auxiliary terminal, the step of pairing with the auxiliary terminal, and creating terminal pairing information corresponding to the auxiliary terminal.

For example, when using a laptop having Bluetooth or Wireless Fidelity device as an auxiliary terminal, the execution terminal may be paired with the laptop in advance. Upon paring, a connection between the execution terminal and the laptop may be established, and terminal paring information corresponding to the connection may be created.

In the embodiment, the method may further include, before the step of receiving data information according to the connection information, the step of initiating an auxiliary input request to the corresponding auxiliary terminal according to the connection information. Upon receiving the auxiliary input request, the auxiliary terminal may display an input window on the screen, obtain data information inputted into the input window and return the data information to the execution terminal.

In another embodiment, after the terminal paring information is created, data information may be inputted directly by the auxiliary terminal and sent to the execution terminal.

In a practical application, the execution terminal is a cell phone having poor quality microphone, and the auxiliary terminal is a Bluetooth microphone having preferable audio parameters. The cell phone and the Bluetooth microphone can be paired by the user in advance. Then, audio is inputted by the Bluetooth microphone, and audio data obtained is sent to the cell phone by the Bluetooth microphone via radio channel. The cell phone may then input the received audio data into the input area corresponding to the cursor position or focus object. For example, the audio data may be inputted into the current chat window of the user; if the user clicks the sending icon, then the audio data will be sent to the friend chatting with the user. A link corresponding to the audio data will be displayed in the chat window of the friend, and the friend can click on the link to play the audio data.

In a practical application, the execution terminal is a cell phone having a low-pixel camera, and the auxiliary terminal is a Bluetooth camera having higher pixels. The cell phone and the Bluetooth camera can be paired by the user in advance. Then, video is shot by the Bluetooth camera, and video data captured is sent to the cell phone by the Bluetooth camera via radio channel. The cell phone can then input the received video data into the input area corresponding to the cursor position or focus object. For example, the video data may be inputted into the current chat window of the user; if the user clicks the sending icon, then the video data will be sent to the friend chatting with the user. The video data will be displayed in the chat window of the friend in the form of a link or an icon, and the friend can click on the link or icon to play the video data.

In a practical application, the execution terminal is a cell phone, and the auxiliary terminal is a wireless keyboard. The cell phone and the wireless keyboard can be paired by the user in advance. For example, the cell phone and the wireless keyboard can be paired using protocols such Bluetooth of 2.4G band, ZigBee and Wireless Fidelity. Then, a string is inputted by the wireless keyboard, and sent to the cell phone by the wireless keyboard via radio channel. The cell phone can then input the received string into the input area corresponding to the cursor position or focus object. For example, the focus object may be a character encoding input bar of the word-selecting window. Then, the received string can be inputted into the character encoding input bar, and corresponding candidate words may be displayed in the word-selecting window for the user to input corresponding text information by selecting appropriate words. An external wireless keyboard is more convenient for inputting, compared to the way of inputting via the soft keyboard on phone screen, thereby increasing the input speed.

In a practical application, the execution terminal is a cell phone with relatively low calculation capability, and the auxiliary terminal is a personal computer, which allows running of image processing application that consumes much CPU resources. When the user wants to input a processed picture into the cell phone, he/she can log in with the same user ID on the server in advance respectively by the cell phone and the personal computer, perform image processing or image editing to the picture in the personal computer, and then upload the processed picture to the server. After receiving the picture, the server is configured to search for corresponding cell phone according to the inputted user ID that the user input when logging in, and send the processed picture to the cell phone. This enables the user to take advantage of the better CPU performance and peripherals of the personal computer to process a picture, improving the input speed.

In an embodiment, as shown in FIG. 3, an input device includes a data receiving module 102, a positioning module 104 and an adding module 106, in which:

The data receiving module 102 is configured to obtain data information sent by an auxiliary terminal.

An auxiliary terminal is a terminal which assists a user to input on an execution terminal. When it is inconvenient to input on the execution terminal, the user can input data information by an auxiliary terminal which has better inputting environment. For example, a PC may be used as an auxiliary terminal to input data information via its physical keyboard.

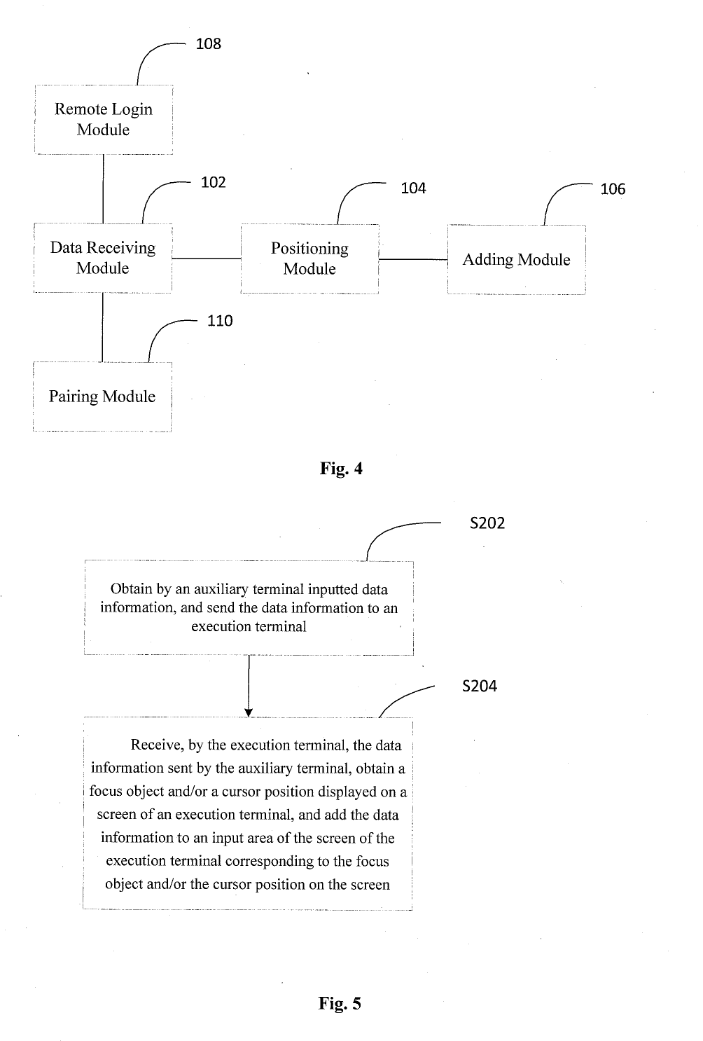

In an embodiment, as illustrated in FIG. 4, the input device may further include a remote login module 108, which is configured to obtain the inputted login information and logging into a server.

In the embodiment, the data receiving module 102 is further configured to receive data information in accordance with the login information forwarded by the server, and the data information is uploaded to the server by the auxiliary terminal corresponding to the login information.

In the embodiment, the user needs to log into the server in advance by inputting an account password on the execution terminal or using a cookie. Meanwhile, the user also needs to log into the server in advance by inputting an account password on the auxiliary terminal or using a cookie.

In the embodiment, the method further include, before the step of receiving data information corresponding to the login information forwarded by the server, the step of initiating an auxiliary input request to the server. The server may obtain a network address of the corresponding auxiliary terminal according to the login information (user ID and login IP, etc.), and forward the auxiliary input request to the auxiliary terminal. An input window can be displayed on the screen of the auxiliary terminal. Data information inputted into the input window can be obtained and uploaded to the server, and then forwarded by the server to the execution terminal.

In another embodiment, upon logging in both by the execution terminal and the auxiliary terminal, data information may be inputted directly by the auxiliary terminal and sent to the server, and then forwarded by the server to the execution terminal. In other words, it is not required to initiate the auxiliary input request by the execution terminal; instead, data information may be inputted directly upon logging in by the auxiliary terminal, and forwarded by the server to the execution terminal. The execution terminal receives the data information.

The positioning module 104 is configured to obtain a focus object and/or a cursor position displayed on a screen of an execution terminal.

The adding module 106 is configured to add the data information to an input area of the screen of the execution terminal corresponding to the focus object and/or the cursor position on the screen.

A focus object is a view object in an active state. View objects may include text input box and rich text input box, etc. A cursor position is the position where to input. By calling the API function of the operating system, the cursor position may be obtained by the positioning module 104. According to the cursor position, an input area and input position in the input area are positioned by the adding module 106. The received data information is inserted into the input position. It is also possible to obtain a focus object by the positioning module 104 by calling the API function of the operating system, and the received data information is added into the input area corresponding to the focus object by the adding module 106.

In an embodiment, the data information may include at least one selected from the group consisting of: video data, image data, text data, audio data and application data.

For example, the user may use a personal PC as an auxiliary terminal to obtain an image by screen capture, and paste the image into a pop-up input window of the auxiliary terminal. The user may also input text data by using a keyboard to input Pinyin, Wubi or other text codes, and selecting the words, or by stylus and tablet, or inputting audio data via a microphone, inputting video data via a camera, inputting application data by copying and pasting.

In the embodiment, the data information is of corresponding MIME-type, for example, Multipurpose Internet Mail Extensions. The adding module 106 is configured to add the data information obtained into the input area corresponding to the focus object and/or cursor position and display according to its MIME-type.

For example, when the data information obtained is video data, its MIME-type is video (video/A, A is the video format, including mpeg, quicktime, etc.); the data information can be previewed by the adding module 106 by calling appropriate interface function for video play. When the data information obtained is audio data, its MIME-type is audio (video/B, B is the audio format, including mid, x-aiff, etc.), which can be previewed by the adding module 106 by calling appropriate interface function for audio play. When the data information obtained is application data, its MIME-type is application, which can be operated by calling appropriate application interface. For example, if the data information obtained is a pdf file, then its MIME-type is application/pdf, which can be previewed by calling appropriate interface function of pdf application.

In another embodiment, the data receiving module 102 is also configured to obtain the terminal pairing information, obtain connection with the auxiliary terminal according to the terminal pairing information, and receive data information according to the connection with the auxiliary terminal.

After pairing with the auxiliary terminal, a long connection may be maintained, or only the network location or device identification of the auxiliary terminal are obtained and recorded in the terminal pairing information. Then, before receiving data sent by the auxiliary terminal, a connection with the auxiliary terminal may be established according to the network location or device identification recorded in the terminal pairing information.

In the embodiment, as illustrated in FIG. 4, the input device further includes a pairing module 11, which is configured to pair the auxiliary terminal, and create terminal pairing information corresponding to the auxiliary terminal.

For example, when using a laptop having Bluetooth or Wireless Fidelity device as an auxiliary terminal, the execution terminal may be paired with the laptop in advance. Upon paring, a connection between the execution terminal and the laptop may be established, and terminal paring information corresponding to the connection may be created.

In the embodiment, the data receiving module 102 is also configured to initiate an auxiliary input request to the corresponding auxiliary terminal according to the connection information. Upon receiving the auxiliary input request, the auxiliary terminal may display an input window on the screen, obtain data information inputted into the input window and return the data information to the execution terminal.

In another embodiment, after the terminal paring information is created, data information may be inputted directly by the auxiliary terminal and sent to the execution terminal.

In an embodiment, as shown in FIG. 5, an auxiliary input method includes the steps of:

Step S202, obtaining, by an auxiliary terminal, inputted data information, and sending the inputted data information to an execution terminal.

Step S204, receiving, by the execution terminal, the data information sent by the auxiliary terminal, obtaining a focus object and/or a cursor position displayed on a screen of the execution terminal, and adding the data information to an input area of the screen of the execution terminal corresponding to the focus object and/or the cursor position on the screen.

In an embodiment, the auxiliary terminal obtains the inputted login information and logs into the server, while the execution terminal also obtains the inputted login information and logs into the server.

In the embodiment, the step of sending the inputted data information by the auxiliary terminal to the execution terminal may further include that:

the auxiliary terminal uploads the inputted data information to the server; the server obtains the login information corresponding to the auxiliary terminal and obtains the execution terminal corresponding to the login information, and sends the data information to the execution terminal.

For example, in a practical application as shown in FIG. 2, the execution terminal is running on a cell phone, while the auxiliary terminal is running on a PC. The user can input login information both by the cell phone and the PC, thereby logging into the server in advance respectively. Then, the user may input Pinyin or Wubi codes via the physical keyboard of the PC, for example, the auxiliary terminal, and input text information by selection of words. An input window may be displayed by the auxiliary terminal to the user for selecting words. When inputting by the auxiliary terminal is completed, the user can click on a sending icon to send the inputted text information to the server. Upon receiving the text information, the server may obtain a network address of the corresponding execution terminal according to the login information corresponding to the auxiliary terminal, and then forward the text information to the execution terminal. Upon receiving the text information, the execution terminal will insert the text information into the input box corresponding to the cursor position.

In the step, the auxiliary terminal forwards, by the server, the inputted data information to the execution terminal which records corresponding login information. This allows an execution terminal to receive simultaneously data information from a plurality of auxiliary terminals, thereby increasing the expansibility.

In another embodiment, the method further includes, before the step of obtaining by the auxiliary terminal the inputted data information and sending the data information to the execution terminal, the step of:

pairing the auxiliary terminal with the execution terminal, and creating corresponding terminal pairing information.

In the embodiment, the step of obtaining by the auxiliary terminal the inputted data information and sending the data information to the execution terminal may further includes:

obtaining, by the auxiliary terminal, the terminal pairing information, and obtaining connection of the auxiliary terminal with the execution terminal according to the terminal pairing information, and sending the inputted data according to the connection with the execution terminal.

For example, in a practical application, the execution terminal is running on a cell phone, while the auxiliary terminal is running on a notebook computer. The user can pair the notebook computer with the cell phone through Bluetooth wireless channel, and establish connection between the execution terminal and the auxiliary terminal. Then, the user can input text information by inputting Pinyin or Wubi codes via the physical keyboard of the notebook computer, for example, the auxiliary terminal, and selecting the words. An input window may be displayed by the auxiliary terminal to the user for selecting words. When inputting by the auxiliary terminal is completed, the user can click on a sending icon to send the inputted text information to the execution terminal through connection between the execution terminal and the auxiliary terminal. Upon receiving the text information, the execution terminal may insert the text information into the input box corresponding to the cursor position.

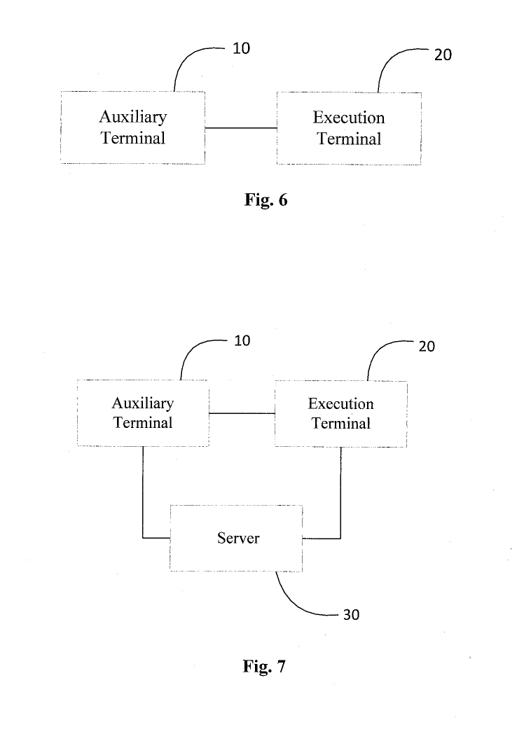

In an embodiment, as shown in FIG. 6, an auxiliary inputting system includes an execution terminal 10 and an auxiliary terminal 20, wherein:

the auxiliary terminal 10 is configured to obtain data information inputted by the auxiliary terminal and send the data information to the execution terminal;

the execution terminal 20 is configured to receive the data information sent by the auxiliary terminal, to obtain a focus object and/or a cursor position displayed on a screen of the execution terminal, and to add the obtained data information to an input area corresponding to the focus object and/or the cursor position on the screen.

In an embodiment, as shown in FIG. 7, the auxiliary inputting system further include a server 30, and the auxiliary terminal 10 is also configured to obtain the login information inputted by the auxiliary terminal 10, and log into the server 30.

The execution terminal 20 is also configured to obtain the login information inputted by the auxiliary terminal 10, and to log into the server 30 according to the login information.

In the embodiment, the auxiliary terminal 10 is also configured to upload the inputted data information to the server 30.

The server 30 is also configured to obtain the login information corresponding to the auxiliary terminal 10, and to obtain the execution terminal 20 corresponding to the login information, and to send the data information to the execution terminal 20.

For example, in a practical application as shown in FIG. 2, the execution terminal is running on a cell phone, while the auxiliary terminal is running on a PC. The user can input login information both by the cell phone and the PC, thereby logging into the server in advance respectively. Then, the user can input text information by inputting Pinyin or Wubi codes via the physical keyboard of the PC, for example, the auxiliary terminal, and selecting the words. An input window may be displayed by the auxiliary terminal to the user for selecting words. When inputting by the auxiliary terminal is completed, the user can click on a sending icon to send the inputted text information to the server. Upon receiving the text information, the server may obtain a network address of the corresponding execution terminal according to the login information corresponding to the auxiliary terminal, and then forward the text information to the execution terminal. Upon receiving the text information, the execution terminal will insert the text information into the input box corresponding to the cursor position.

The auxiliary terminal forwards, by the server, the inputted data information to the execution terminal which records corresponding login information. This allows an execution terminal to receive simultaneously data information from a plurality of auxiliary terminals, thereby increasing the expansibility.

In another embodiment, the auxiliary terminal 10 is also configured to pair with the execution terminal 20 and to create corresponding terminal pairing information. In the embodiment, the execution terminal 20 will also create corresponding terminal pairing information upon pairing with the auxiliary terminal 10.

In the embodiment, the auxiliary terminal 10 is also configured to obtain the terminal pairing information, and to obtain connection with the execution terminal 20 according to the terminal pairing information, and to send the inputted data according to the connection with the execution terminal 20.

The execution terminal 20 is configured to obtain the terminal pairing information, and to obtain connection with the auxiliary terminal 10 according to the terminal pairing information, and to send the inputted data according to the connection with the auxiliary terminal 10.

For example, in a practical application, the execution terminal is running on a cell phone, while the auxiliary terminal is running on a notebook computer. The user can pair the notebook computer with the cell phone through Bluetooth wireless channel, and establish connection between the execution terminal and the auxiliary terminal. Then, the user can input text information by inputting Pinyin or Wubi codes via the physical keyboard of the notebook computer, for example, the auxiliary terminal, and selecting the words. An input window may be displayed by the auxiliary terminal to the user for selecting words. When inputting by the auxiliary terminal is completed, the user can click on a sending icon to send the inputted text information to the execution terminal through connection between the execution terminal and the auxiliary terminal. Upon receiving the text information, the execution terminal may insert the text information into the input box corresponding to the cursor position.

By the above input method, input device, auxiliary input method and auxiliary inputting system, operation to the inputted data information can be separated from the execution terminal to an auxiliary terminal which has better inputting conditions, for example, with larger keyboard and more types of input devices. Thus, the user is allowed to use more convenient inputting tools of the auxiliary terminal, and thereby increasing the input speed.

Those skilled in the art will understand that implementation of all or part of the process of the method in the above embodiments can be achieved by a computer program to instruct relevant hardware. The program may be stored in a computer-readable storage medium, which, when executed, may implement the method according to the above embodiments of the present disclosure. The storage medium may be magnetic disk, optical disk, ROM or RAM, etc.

The embodiments are chosen and described in order to explain the principles of the disclosure and their practical application so as to allow others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

1. An input method, comprising:
obtaining data information sent by an auxiliary terminal;
obtaining a focus object and/or a cursor position displayed on a screen of an execution terminal; and
adding the data information to an input area of the screen of the execution terminal corresponding to the focus object and/or the cursor position on the screen.

2. The input method of claim 1, further comprising:
before obtaining the data information sent by the auxiliary terminal, obtaining login information inputted by the auxiliary terminal and logging in a server according to the login information;
wherein obtaining the data information sent by the auxiliary terminal comprises receiving data information in accordance with the login information forwarded by the server, and uploading, by the auxiliary terminal corresponding to the login information, the data information to the server.

3. The input method of claim 1, wherein obtaining data information sent by the auxiliary terminal comprises:
obtaining terminal pairing information;
obtaining connection of the execution terminal with the auxiliary terminal according to the terminal pairing information; and
receiving data information according to the connection with the auxiliary terminal.

4. The input method of claim 3, further comprising: before obtaining data information sent by the auxiliary terminal,
pairing the execution terminal with the auxiliary terminal, and
creating terminal pairing information corresponding to the auxiliary terminal.

5. The input method of claim 1, wherein the data information comprises at least one selected from the group consisting of: video data, image data, text data, audio data and application data.

6. An input device, comprising:
a data receiving module, configured to obtain data information sent by an auxiliary terminal;
a positioning module, configured to obtain a focus object and/or a cursor position displayed on a screen of an execution terminal; and
an adding module, configured to add the data information to an input area of the screen of the execution terminal corresponding to the focus object and/or the cursor position on the screen.

7. The input device of claim 6, further comprises a remote login module 108, configured to obtain login information inputted by the auxiliary terminal and logging into a server according to the login information; wherein the data receiving module is configured to receive data information in accordance with the login information forwarded by the server, and the data information is uploaded to the server by the auxiliary terminal corresponding to the login information.

8. The input device of claim 6, wherein the data receiving module is further configured to obtain the terminal pairing information, obtain connection of the execution terminal with the auxiliary terminal according to the terminal pairing information, and receive data information according to the connection with the auxiliary terminal.

9. The input device of claim 8, further comprising: a pairing module, configured to pair the execution terminal with the auxiliary terminal, and create terminal pairing information corresponding to the auxiliary terminal.

10. The input device of claim 6, wherein the data information comprises at least one selected from the group consisting of: video data, image data, text data, audio data and application data.

11. An auxiliary input method, comprising:
obtaining, by an auxiliary terminal, inputted data information, and sending the inputted data information to an execution terminal; and
receiving, by the execution terminal, the data information sent by the auxiliary terminal, obtaining a focus object and/or a cursor position displayed on a screen of the execution terminal, and adding the data information to an input area of the screen of the execution terminal corresponding to the focus object and/or the cursor position on the screen.

12. The auxiliary input method of claim 11, wherein before obtaining by the auxiliary terminal the inputted data information and sending the data information to the execution terminal, the auxiliary terminal obtains the inputted login information and logs into the server according to the login information, while the execution terminal also obtains the inputted login information and logs into the server.

13. The auxiliary input method of claim 11, wherein sending the inputted data information by the auxiliary terminal to the execution terminal comprises:
uploading, by the auxiliary terminal, the inputted data information to the server; and
obtaining, by the server, the login information corresponding to the auxiliary terminal, obtaining the execution terminal corresponding to the login information, and sending the data information to the execution terminal.

14. The auxiliary input method of claim 11, further comprising: before obtaining by the auxiliary terminal the inputted data information and sending the data information to the execution terminal,
pairing the auxiliary terminal with the execution terminal, and creating corresponding terminal pairing information.

15. The auxiliary input method of claim 14, wherein obtaining by the auxiliary terminal the inputted data information and sending the data information to the execution terminal comprises:
obtaining, by the auxiliary terminal, the terminal pairing information, and obtaining connection of the auxiliary terminal with the execution terminal according to the terminal pairing information, and sending the inputted data according to the connection with the execution terminal.

16. An auxiliary inputting system, comprising:
an auxiliary terminal, configured to obtain data information inputted by the auxiliary terminal and send the inputted data information to an execution terminal; and
an execution terminal, configured to receive the data information sent by the auxiliary terminal, to obtain a focus object and/or a cursor position displayed on a screen of the execution terminal, and to add the data information to an input area corresponding to the focus object and/or the cursor position on the screen.

17. The auxiliary inputting system of claim 16, wherein the auxiliary terminal is further configured to obtain the inputted login information and log into the server; and the execution terminal is further configured to obtain login information inputted by the auxiliary terminal and log into the server according to the login information.

18. The auxiliary inputting system of claim 17, wherein the auxiliary terminal is further configured to upload the inputted data information to the server; and
the server is further configured to obtain the login information corresponding to the auxiliary terminal, obtain the execution terminal corresponding to the login information, and send the data information to the execution terminal.

19. The auxiliary inputting system of claim 16, wherein the auxiliary terminal is further configured to pair with the execution terminal, and create corresponding terminal pairing information.

20. The auxiliary inputting system of claim 19, wherein the auxiliary terminal is further configured to obtain the terminal pairing information, and to obtain connection with the execution terminal according to the terminal pairing information, and to send data information inputted by the auxiliary terminal according to the connection with the execution terminal.
